(19) United States
(12) Patent Application Publication
(10) Pub. No.: US 2015/0178380 A1
(43) Pub. Date: Jun. 25, 2015

(54) MATCHING ARBITRARY INPUT PHRASES TO STRUCTURED PHRASE DATA

(71) Applicant: OpenGove, Inc., Mountain View, CA (US)

(72) Inventor: Matthew SEAL, Sunnyvale, CA (US)

(73) Assignee: OpenGove, Inc., Mountain View, CA (US)

(21) Appl. No.: 14/135,100

(22) Filed: Dec. 19, 2013

(51) Int. Cl. G06F 17/30; G06F 17/27

(52) U.S. Cl. CPC G06F 17/30684; G06F 17/2785

(57) ABSTRACT

Techniques are disclosed for comparing data between dissimilar data hierarchies. Techniques provide an entity pool comprising multiple entities having established relationships and hierarchies. A user selects data from one hierarchy, and a mapping to a node in a structure that provides a normalized hierarchy is found. After identifying a node mapped to the data selection, elements corresponding to a second hierarchy that also maps to the same node (or otherwise obtained from using known natural language processing techniques) are identified. Doing so allows comparable elements of otherwise dissimilar hierarchies to be identified.

### BACKGROUND

1. Field

Embodiments presented herein generally relate to techniques for natural language processing, classification, and text mining. More specifically, techniques are disclosed for classifying arbitrary input phrases based on structured phrase data.

2. Description of the Related Art

Open data, the concept of making certain data freely available to the public, is of growing importance. For example, demand for government transparency is increasing, and in response, governmental entities are releasing a variety of data to the public. One example relates to financial transparency for governmental entities (e.g., a city or other municipality) making budgets and other finances available through data accessible to the public. Doing so allows for more effective public oversight. For example, a user may analyze the budget of a city to determine how much the city is spending for particular departments and programs. Additionally, users may compare budgetary data between different cities to determine, for example, how much other cities are spending on respective departments. This latter example is particularly useful for a department head at one city who wants to compare spending, revenue, or budgets with comparable departments in other cities.

An issue that arises in providing public access to this kind of financial data is presenting the data in a useful manner. For instance, in the previous example, budgetary data for a given city government is often voluminous. Consequently, users accessing the data may have difficulty discerning relevant information. To address such an issue, computer applications may parse and process the budgetary data in a manner that is presentable to a user (e.g., by generating graphs, charts, and other data analytics).

However, comparing such data with the budgetary data of other cities introduces additional complexities. One such complexity is resolving differently-labeled departmental entities. More specifically, departments providing the same function in two cities may use different names, making comparisons difficult. As an example, a city department that handles water sewage could be called “Sewage Processing” in one city and “Water Treatment” in another city. Another complexity is differences between organizational structures between cities. In such cases, hierarchical differences between the departments of different cities may create further issues. For example, although “Sewage Processing” may be its own department in one city, “Water Treatment” may be a sub-department of a “Public Works” department in another city. Software applications rely on natural language processing (NLP) techniques to resolve the labels into similar entities, but many current approaches require a substantial amount of preprogramming (i.e., hard-coding associations and relationships to the entities themselves). Such approaches are not scalable and are often error prone.

### SUMMARY

Embodiments presented herein include a method for obtaining data corresponding to comparable elements in a first hierarchy and a second hierarchy. This method may generally include receiving a selection of one or more elements in the first hierarchy. This method may also include identifying a mapping from the one or more elements in the first hierarchy to a node in an entity pool. Upon determining one or more elements in the second hierarchy map to the identified node in the entity pool, data corresponding to the one or more elements in the first hierarchy and the one or more elements in the second hierarchy is retrieved and returned.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates an example computing environment, according to one embodiment.

FIGS. 2A and 2B illustrate an example interface of a financial transparency application, according to one embodiment.

FIG. 3 illustrates an example entity pool, according to one embodiment.

FIG. 4 illustrates an example of mentions in two different departmental hierarchies to entities mapped to a common entity in an entity pool, according to one embodiment.

FIG. 5 illustrates a method for matching a selection of a label in a first hierarchy to a corresponding label in a second hierarchy, according to one embodiment.

FIG. 6 illustrates an example server computing system configured with an application configured to match an input word data selection to output word data based on a related entity in an entity pool, according to one embodiment.

### DETAILED DESCRIPTION

Embodiments presented herein provide techniques for comparing data between dissimilar data hierarchies. A user selects data from one hierarchy, and a mapping to a node in a structure that provides a normalized hierarchy is found. After identifying a node mapped to by the data selection, elements corresponding to a second hierarchy that also map to the same node are identified. Doing so allows comparable elements of otherwise dissimilar hierarchies to be identified. As a result, users may make meaningful comparisons across different data sets, even where the data sets do not share a common organizational or hierarchical structure, but nevertheless store semantically comparable information.

Consider financial budget data for two cities. A chart of accounts for both cities may account for departments, funds, services, and revenues differently while still providing comparable services and functions to its citizens. For instance, departments in both cities that serve similar functions might not share the same name. For example, a “Sewage Processing” department in City A may be referred to as a “Water Treatment” department in City B. This creates difficulty for an individual in one city (e.g., a citizen, city planner, administrator, etc.) to compare the budget data of the other city.

To address this issue, the techniques described herein provide an entity pool that may be used to determine a mapping for elements of one hierarchy, such as a word reference to an entity (a “mention”), to other elements in another hierarchy. That is, mentions from different hierarchies referring to a particular node (an “entity”) may map to a similar or identical entity in the entity pool, even if the mentions across the hierarchies are not composed of identical strings. Thus, the entity pool may include a node for the entity to which both “Sewage Processing” and “Water Treatment” are mapped. In one embodiment, an application receives a selection of a mention (e.g., “Sewage Processing”) corresponding to an entity in a first hierarchy (e.g., City A) and a selection of a second hierarchy (e.g., City B). The application iterates through the entity pool to identify the corresponding entity that maps to the mention. Once the entity is identified, the application iterates through the second hierarchy in the entity pool to identify the mention that refers to the identified entity.

For instance, techniques described herein may be used in a financial transparency application which allows users to view and analyze budgetary data of state and local governments. Using the financial transparency application, the user may, for example, view the amount of money spent on various city departments. The financial transparency application may provide the user with graphs and other analytical structures for further analysis.

Importantly, in one embodiment, the user may compare the departmental budgets across multiple cities. Because similar departments may be labeled and structured differently in city hierarchies, the financial transparency application may use an entity pool to identify corresponding department names, funds, budget items, etc., in each city. That is, the departmental names serve as “mentions” that refer to a functioning “entity.” For example, given a department name selection of “Sewage Processing” in City A and a selection for City B, the financial transparency application iterates through the entity pool to identify an entity associated with City A's “Sewage Processing.” Once identified, the financial transparency application iterates through City B's hierarchy and searches for the identified entity. If the identified entity or closely-related identity is part of City B's hierarchy, then the financial transparency application may identify the corresponding department name.

Because the entity pool defines hierarchical relationships between entities, the entity pool may be used to determine a mapping of a mention in one hierarchy to a mention in another hierarchy based on a similar or identical entity. Advantageously, in practical settings, users are better able to compare information as a result. Additionally, because the entity pool is generated and refined using unsupervised learning techniques, the entity pool may reliably be scaled to evaluate multiple hierarchies.

The following description relies on a financial transparency software application as a reference example resolving dissimilar data sets which are organized in a hierarchical fashion by using an entity pool. However, one of skill in the art will recognize that embodiments are applicable in other contexts related to resolving word selection data of separate structural hierarchies into comparable entities. For example, embodiments may be used in an application to compare and analyze disclosed earnings data between competing business organizations. As another example, embodiments may be used in comparing other, non-financial metrics between local governments, such as crime statistics, where each city uses a different set of descriptions for classifying crime or characterizing statistics.

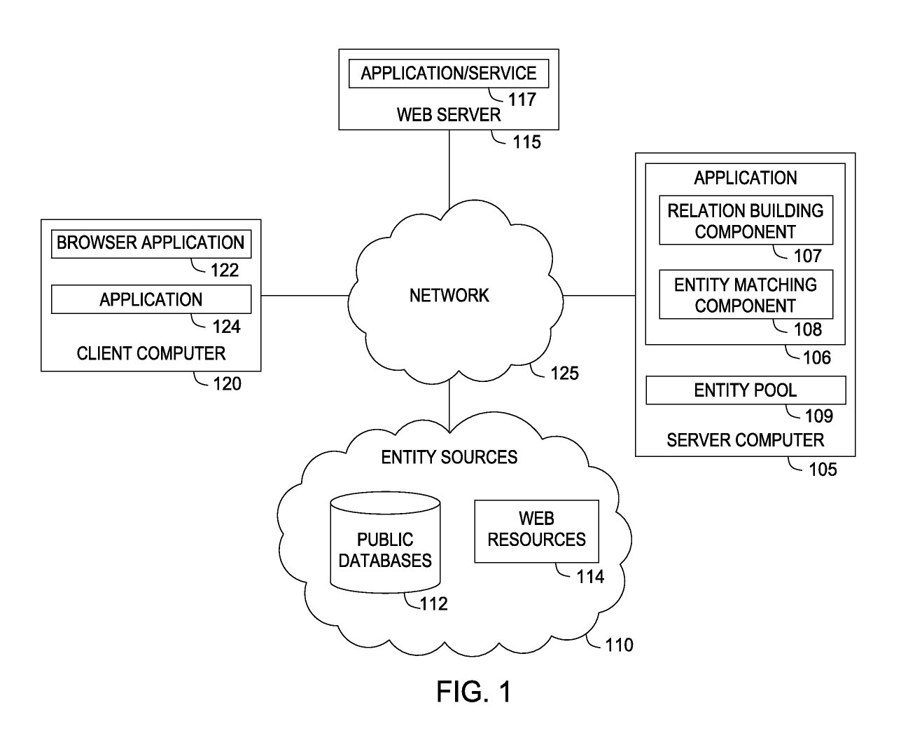

FIG. 1 illustrates an example computing environment 100, according to one embodiment. As shown, the computing environment 100 includes a server computer 105. The server computer 105 may be a physical computing system (e.g., a system in a data center) or a virtual computing instance executing within a computing cloud. In one embodiment, the server computer 105 hosts a financial transparency application 106. The application 106 allows a user (e.g., an administrator, city planner, citizen, etc.) to browse budgetary data of different state and local governments.

For example, users of application 106 may retrieve budget information for multiple cities and compare expenditures between specific departments of each city. For instance, assume the user wants to compare City A's expenditures on its “Auditor-Controller” department relative to how much City B is spending for comparable functions and services. In such a case, the user, e.g., through an interface on a client computer 120, may select “City A” and “Auditor-Controller,” and then also select “City B.” The application 106 receives the data selections and iterates through an entity pool 109 to identify an entity corresponding to the selection of “Auditor-Controller” in City A. After identifying the entity associated with “Auditor-Controller” for City A, the application 106 iterates through the City B hierarchy to identify an identical or similar entity. Doing so allows the application 106 to retrieve the budget item in City B that corresponds to the budget item City A's “Auditor-Controller” (because City B may label the budget item with a different name, such as “Accounting”). Once resolved, the application 106 retrieves budget item data corresponding to both departments and returns the data to the client computer 120.

In one embodiment, entity pool 109 is a grouping of objects, also referred to as “entities” and relationships between such entities. An entity itself is a group of strings, referred to as “mentions.” Each mention refers to an entity in the entity pool 109. A “mention” may also include contextual information relevant to associating the mention to an entity. In the previous example, “Auditor-Controller” and “Accounting” are mentions that refer to the departmental entity serving a similar accounting function. The application 106 generates the entity pool 109 based on various entity sources 110. Such entity sources 110 may include documents from public databases 112, such as charts of accounts and other budget documents from cities. Application 106 may parse web resources 114 (e.g., such as online encyclopedia pages, government websites, etc.) to scrape mentions and relevant contextual information (e.g., the frequency upon which the mention appears, the location of the mention in the resource, other words adjacent to the mention, and so on). Techniques used to parse the web resources 114 are described further below.

A relation building component 107 determines relationships between the entities in the entity pool 109 from the contextual information obtained after parsing the web resources 114. That is, the relationship building component 107 defines how a given entity relates to other entities in the entity pool 109. For example, given contextual information corresponding to certain entities, the relation building component 107 may identify parent-child relationship sets between the entities. Once the relationships are generated, an entity matching component 108 maps the entities to the relationship sets. The entity pool 109 is generated by clustering the relationships using known clustering algorithms. For example, a greedy hierarchical agglomerative clustering algorithm may be effective in the present context. Thereafter, the application 106 may use the entity pool to resolve different mentions and retrieve budget data for department names associated with the entity, given a selection of a department name.

Note, even if a given mention is absent in a generated entity pool, the relation building component 107 may still map the mention to an entity if semantically-related mentions are already present in the entity pool. In such a case, an ontology may act as a thesaurus for some mentions. For example, assume a mention of “Law Enforcement” is not in the entity pool, and that “Police” is present in the entity pool. In such a case, the financial transparency application 106 may use natural language processing techniques to match to “Police” and “Law Enforcement.”

In one embodiment, the financial transparency application 106 may be hosted as an application/service on a web server 115. The web server 115 hosts an application/service 117 that provides the financial transparency service. A user of a client computer 120 may access the application/service 117 using a web browser application 122. The application/service 117 communicates with server computer 105 via network 125 to access the entity pool 109. The application/service 117 may retrieve user-requested data from the entity pool 109 and, after receiving the data, present the data to browser application 122 through a web interface. Alternatively, the financial transparency application may be executed on the client computer 120. For example, the client computer 120 may download a software application 124 via the network 125 from a server.

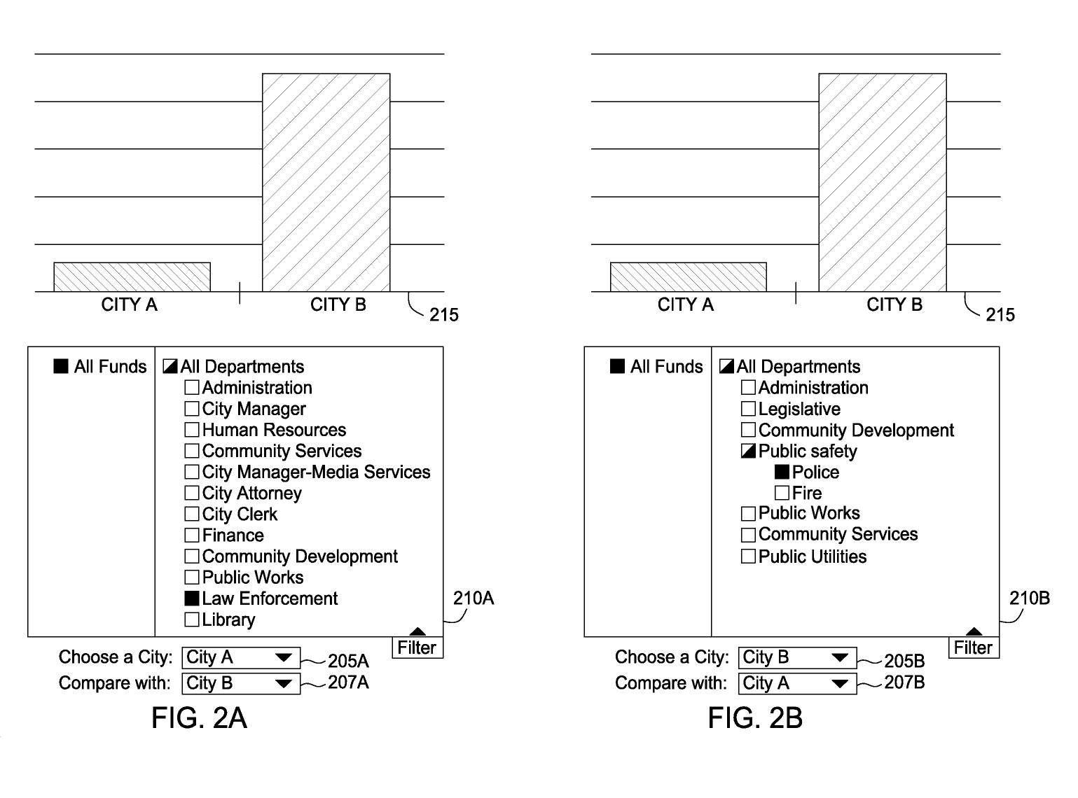

FIGS. 2A and 2B illustrate an example interface of a financial transparency application, according to one embodiment. As described, the financial transparency application allows users to evaluate comparable financial and budgetary data related to different cities. For example, a user may select a city by clicking on a dropdown box 205. Once the user selects a city, the application may display financial information, grouped by department, on a graph 215 on the interface. The financial information presented may correspond to the accounting and budget structure of the city. Further, the user may compare the budgets of other cities with the currently selected city. To do so, the user selects a second city by clicking on the dropdown box 207. As a default, the financial transparency application may present budgetary data corresponding to all departmental funds. To refine the selection, the user may filter departments to display on graph 215 through a filter menu 210. The department names on the filter menu 210 correspond to the names given by the city selected in the dropdown box 205. Note that the interface may also provide the capability of comparing more than two cities.

In the example of FIG. 2A, a user is comparing a budget for the police department entity of City A (selected from the dropdown box 205A) to a budget the police department entity of City B (selected from dropdown box 207A). Note, importantly, because the two cities may have different accounting and ledger structures, simply identifying the same line items in two budgets is not possible. Instead, in one embodiment, the financial transparency application maps the selected line items from City A to an entity pool. Once mapped, the financial transparency application identifies the best matching line item when comparing budgetary data across different cities. As shown in the filter menu 210A, the user has selected to filter results to “Law Enforcement.” By filtering the results to “Law Enforcement,” the graph 215 displays information relating to only the police departments in City A and City B. FIG. 2B depicts the interface where the user compares the police department entity of City B (selected from the dropdown box 205B) to the police department entity of City A (selected from dropdown box 207B). As shown in the filter menu 210B, the user has selected to filter results to “Police.”

Note that the police department entities are labeled differently in City A (“Law Enforcement”) and City B (“Police”). It is common for departments serving relatively identical functions to have different names across different cities. To be able to compare the two departments, the financial transparency application resolves the word selections into a common entity located in a generated entity pool that establishes mappings between word mentions and entities. Doing so allows the financial transparency application to identify the corresponding department in the city whose department is being compared. After identifying the corresponding department, the financial transparency application is able to retrieve the relevant budgetary data associated with each department and present the data to the user (e.g., through graph 215).

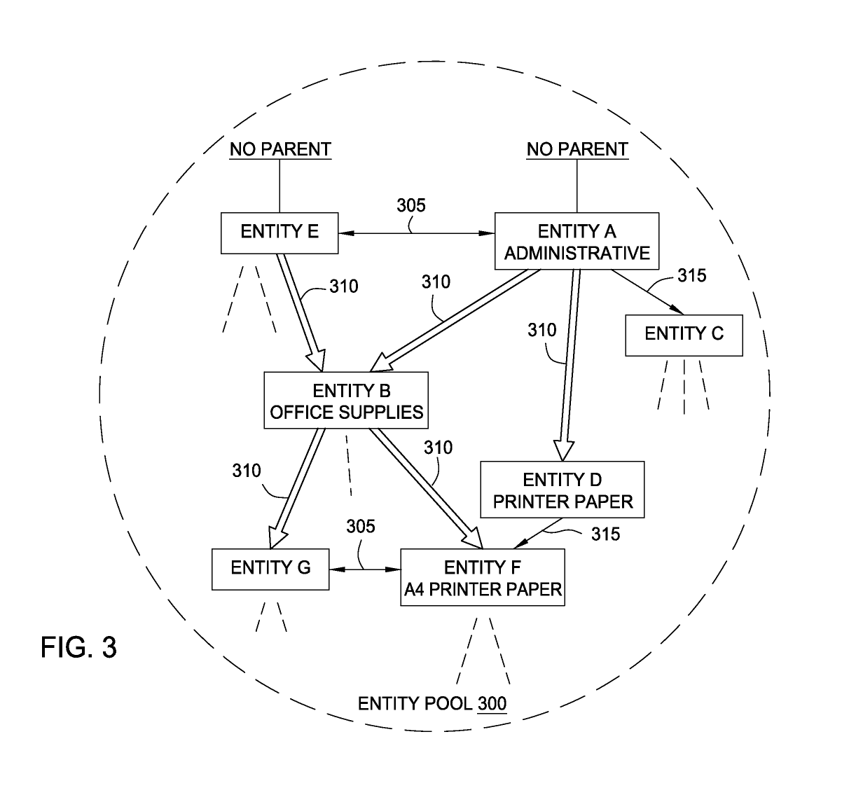

FIG. 3 illustrates an example of an entity pool 300, according to one embodiment. The entity pool 300 maps elements of a hierarchy to nodes (entities) in the pool. More specifically, the entity pool 300 defines hierarchical relationships between entities in the pool. For example, an entity may be a child of another entity or subset of another entity. As noted, each entity itself may correspond to a collection of “mentions” and other metadata used to define a given entity. Further, the entity pool 300 defines semantic relationships between the entities. Specifically, relationships between nodes may be weighted by a similarity to one another, based on contextual information obtained from public sources. For example, although an entity associated with a “Police Department” may be an entirely separate entity associated with a “Fire Department,” the relationship between the entities may nevertheless be highly weighted because both entities semantically relate to an overall “Public Safety” department.

To generate the entity pool, in one embodiment, a parsing component in the financial transparency application may scrape data from public sources, such as an online encyclopedia or other authoritative or semi-authoritative source. For example, the parsing component may evaluate a general description of a chart of accounts available in an online encyclopedia. As known, a chart of accounts is a list of accounts defining items for which money is spent or received for a given city department. A governmental entity may use the chart of accounts to organize finances of the entity by separating expenditures, revenues, assets, and liabilities of that entity. As such, the chart of accounts is a densely structured document that provides identifiable terminology and clearly defines hierarchies within a given city. The financial transparency application parses each page to retrieve mentions and contextual metadata related to each mention. For example, such metadata may include a frequency of the mention appearing in the page, each location that the mention appears in the page, and descriptions of the mention. Additionally, the financial transparency application navigates through pages linked within the specified pages and collects information from the linked pages. After parsing the data, the entity matching component may associate each mention with an entity in an entity pool. Each entity in the pool provides a data structure storing, collectively, all the mentions and attributes of an entity. As an entity is associated with more mentions, the financial transparency tool may determine a common name for the entity from the aggregate of mentions for that entity. Further, the relation building component may identify relationships between entities. For example, the relation building component may define relationships between departments, ledger items, fund names, etc. Also, the relation building component may determine that an entity corresponding to a “Public Works” department is frequently related to an entity corresponding to a “Sewage Treatment” department based on observed relationships between mentions collected from data sources. As a result, the relation building component may determine weights between the entities. As the entity pool 300 is populated with more data, the entity pool 300 becomes further refined.

The financial transparency application may scrape data from other public sources to generate the entity pool 300. For instance, another public source that the financial transparency application may use is a city's chart of accounts. The chart of accounts provides word mentions corresponding to each of the city's departments, and further, while parsing the chart of accounts, the financial transparency application may record other contextual metadata related to each mention. As more information from cities are consolidated into the entity pool 300, the more refined the entity pool 300 may become.

Further, the parsing component may scrape additional public sources in combination with other public sources. For example, ground truth data (i.e., objective data from a third party source) may be established using online sources for the entity pool 300, and the charts of accounts for different cities may later be parsed to refine each entity in the existing entity pool 300. For instance, as more contextual information is added to the entity pool from the charts of accounts (or any other source), the relation building component may further ascertain similarities or differences between existing entities. Additionally, the relation building component may split entities after identifying additional nuances between mentions associated with the entity based on further collected contextual information.

After retrieving mentions and contextual information from the sources and associating the mentions with entities, the relation building component defines the relations between entities in the entity pool 300. The relation building component may define a relation between two nodes (i.e., between two entities) based on hierarchical information and contextual information collected when retrieving each mention. As shown in FIG. 3, relationships between entities are illustrated using edges connecting nodes in the pool. The two-way arrow 305 between entities depicts overlapping entities. For example, entities E and A are depicted as overlapping entities. Entities E and A may overlap due to similarities between each other but, due to nuances between the two, are not consolidated into the same entity. The double-lined arrow 310 depicts that the entity being pointed to is a “child of” a parent entity. For example, Entity B is a child-of parent entities E and A. A one-way arrow 315 depicts that an entity being pointed to is a subset of another entity. Of course, FIG. 3 depicts only a few relationships between each entity, but in practice, each entity may relate to more entities than described herein (as depicted by the dotted lines). For example, an entity can be a child of multiple entities. As another example, an entity can be a child of a certain entity as well as a sub-part of that entity. Generally, relationships between entities in the entity pool 300 may be inclusive (e.g., like relationships found between sets of a Venn diagram) while also allowing arbitrary relationships to be defined.

In the example of FIG. 3, entity pool 300 corresponds to line items in a city's budget. As shown, an Entity A is labeled “Administrative,” Entity B is labeled “Office Supplies,” Entity D is labeled “Printer Paper,” and Entity F is labeled “A4 Printer Paper.” Illustratively, Entities B and D are children of Entity A. Additionally, Entity F is a child of Entity B but also a subset of Entity D. The relation building component may ascertain various relationships between each entity as more data is collected.

In one embodiment, edges identifying relationships between entities may be assigned weighted measures based on the relational similarity between the entities. The financial transparency application may use the assigned weighted measures of the entities to identify a mapping of a label in one hierarchy to a label in another hierarchy in the event that both labels do not match to an identical entity. For example, if a particular label associated with a certain Entity X in a first hierarchy, and the second hierarchy has no corresponding label associated with Entity X in the entity pool, the financial transparency application may identify another Entity Y that has a higher weight measure between Entity X relative to other entities in the entity pool. In one embodiment, if a given selection of a label does not directly map to another label in a second hierarchy, the financial transparency application may be configured to identify entities in the second hierarchy whose weights exceed a predetermined threshold. The financial transparency application may then prompt the user to select one of the labels associated with the identified entities as being the label corresponding to the selection.

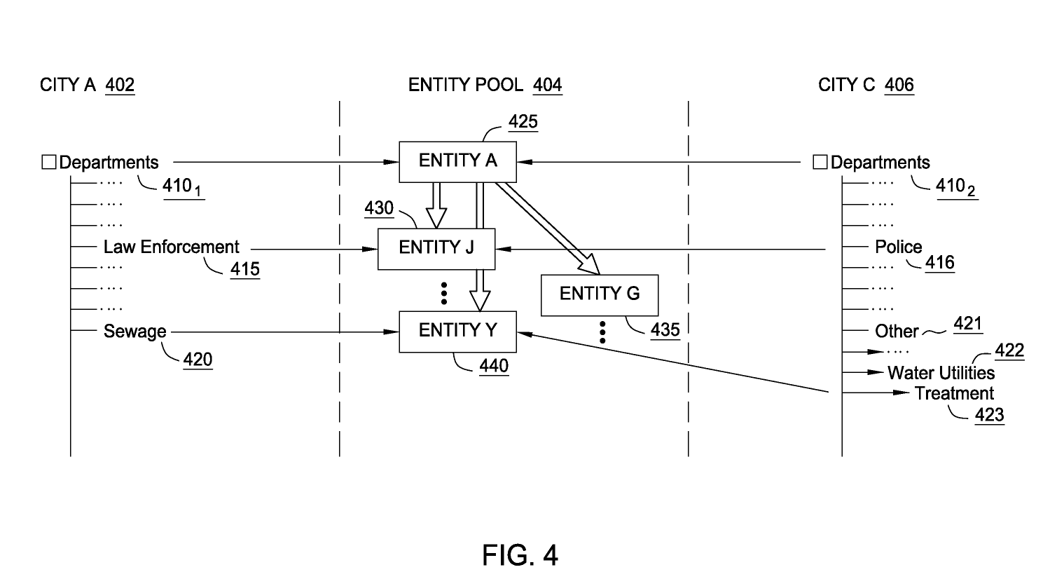

FIG. 4 illustrates an example of mentions in two departmental hierarchies mapped to a common entity in an entity pool 404, according to one embodiment. As shown, City A 402 and City C 406 each provide a departmental hierarchy, with “Departments” 410₁₋₂ being at the top of the hierarchy.

In this example, only the respective departments for each city's police department and sewage treatment department are shown. Specifically, City A 402 lists a “Law Enforcement” department 415 and a “Sewage” department 420, and City C 406 lists a “Police” department 416 and a “Treatment” department 423. The “Treatment” department 423 itself is nested under a “Water Utilities” department 422 which itself is nested under an “Other” categorization 421.

Each department in the departmental hierarchy of City A 402 map to an entity in entity pool 404. “Department” 410₁ maps to Entity A 425. “Law Enforcement” 415 maps to Entity J 430. “Sewage” 420 maps to Entity Y 440. Similarly, each department in the department hierarchy of City C 406 maps to an entity in entity pool 404. “Department” 410₂ maps to Entity A 425. “Police” 416 maps to Entity J 430. “Treatment” 423 maps to Entity Y 440. Illustratively, Entity A serves as a parent entity to Entity J 430, Entity G 435, and Entity Y 440.

Other departments in both City A 402 and City C 406 may map to appropriate entities in Entity Pool 404 (e.g., such as Entity G 435). Additionally, although not shown in FIG. 4, City A 402 and City C 406 themselves may be mapped to different entities.

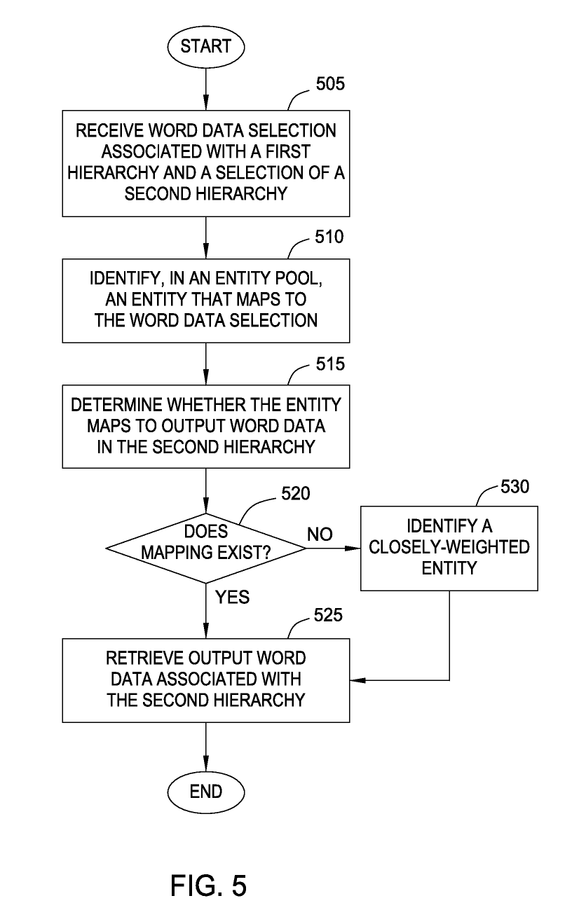

FIG. 5 illustrates a method for matching elements of separate hierarchies by mapping descriptive terms of each hierarchy into an entity pool, according to one embodiment. Using the entity pool mappings in FIG. 4, assume that a user wants to compare budgetary data of police departments in City A 402 and City C 406. The user selects the “Law Enforcement” department 415 of City A 402 on the interface of the financial transparency application and also selects City C 406.

At step 505, the application receives the word data selection (i.e., “Law Enforcement” 415) associated with the first hierarchy (i.e., City A 402) and a selection of a second hierarchy (i.e., City C 406). The financial transparency application evaluates the entity pool to determine what entity most corresponds to the terms or nodes of the first hierarchy specified by the user. At step 510, the application identifies an entity associated with the word data selection. To do so, the financial transparency application starts at the root of the entity pool 404 and uses the known relationships between entities provided by the entity pool to identify that the selection of “Law Enforcement” 415 from the chart of accounts of City A 402 maps to Entity J 430.

At step 515, once the entity is identified, the application iterates through the second hierarchy (i.e., City C 406) in the entity pool to identify a mapping of elements (e.g., a department name) to a comparable entity. In this example, the financial transparency application iterates through the entity pool 404 to identify a mapping to Entity J 430 from the chart of accounts of city C 406. If a mapping exists, then the financial transparency application retrieves data corresponding to police departments in both City A 402 and City C 406. In this case, Police 416 also maps to Entity J 430. Because a mapping is present in the City C 406 hierarchy, the financial transparency application resolves the departments and retrieves budgetary data corresponding to the departments.

However, if a direct mapping to a specific entity in the entity pool is not found (i.e., no department in City C 406 maps to Entity J 430), the financial transparency application may instead rely on assigned weights between entities to determine a relatively close mapping. For example, an entity having a weight exceeding a specified threshold may be used in place of an identical entity. In an alternative embodiment, the financial transparency application may present mappings from elements in the second hierarchy to closely weighted relationships to the user and prompt the user to select from the mappings. Alternatively, if a direct mapping to a specific entity in the entity pool is not found, the financial transparency application may use natural language processing techniques to determine an appropriate mapping.

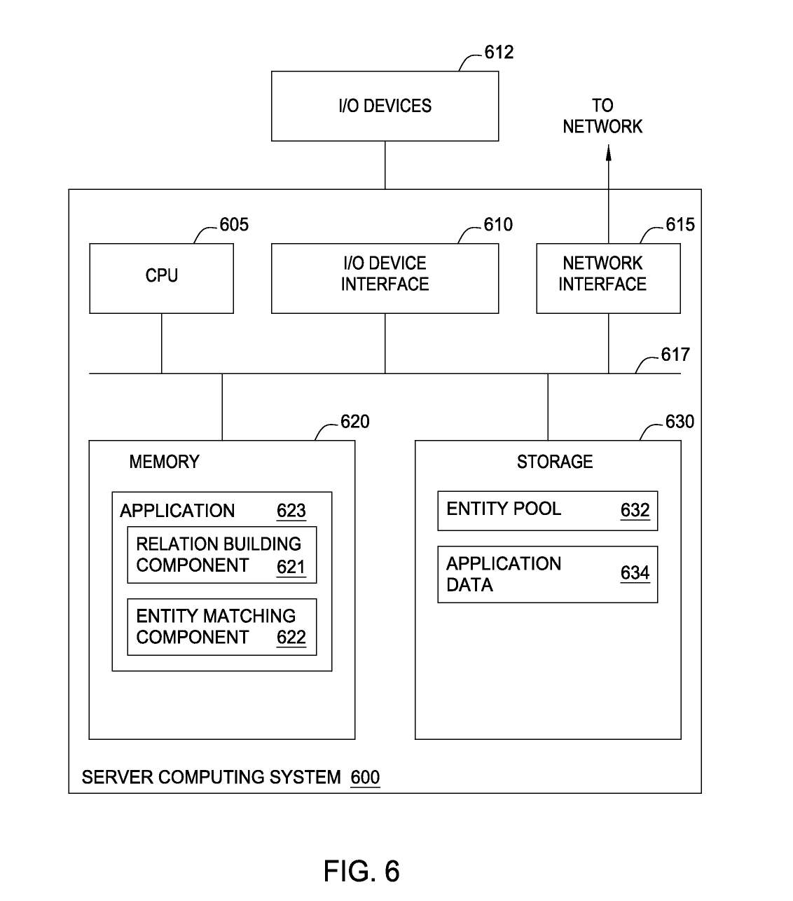

FIG. 6 illustrates an example server computing system 600 configured with an application configured to match data selections to a related entity of an entity pool, according to one embodiment. As shown, the computing system 600 includes, without limitation, a central processing unit (CPU) 605, a network interface 615, a memory 620, and storage 630, each connected to a bus 617. The computing system 600 may also include an I/O device interface 610 connecting I/O devices 612 (e.g., keyboard, display and mouse devices) to the computing system 600. Further, in context of this disclosure, the computing elements shown in computing system 600 may correspond to a physical computing system (e.g., a system in a data center) or may be a virtual computing instance executing within a computing cloud.

The CPU 605 retrieves and executes programming instructions stored in the memory 620 as well as stores and retrieves application data residing in the storage 630. The interconnect 617 is used to transmit programming instructions and application data between the CPU 605, I/O devices interface 610, storage 630, network interface 615, and memory 620. Note, the CPU 605 is included to be representative of a single CPU, multiple CPUs, a single CPU having multiple processing cores, and the like. And the memory 620 is generally included to be representative of a random access memory. The storage 630 may be a disk drive storage device. Although shown as a single unit, the storage 630 may be a combination of fixed and/or removable storage devices, such as fixed disc drives, removable memory cards, or optical storage, network attached storage (NAS), or a storage area-network (SAN).

Illustratively, the memory 620 includes an application 623. The application 623 itself includes a relation building component 621 and an entity matching component 622. And the storage 630 includes an entity pool 632 and application data 634. The application 623 generally provides one or more software applications and/or computing resources accessed over a network 120 by users. More specifically, the application 623 processes budgetary data (e.g., application data 634) belonging to local governments and presents the data to a user through graphs and other analytics. The application 623 generates the entity pool 632 using existing entity sources, such as publicly available budget sources and charts of accounts from different cities. The relation building component 621 defines relationships between each entity in the entity pool 632. The entity matching component 622 associates relationship sets between entities. The application 623 uses the entity pool 632 to determine related entities within a hierarchy and also within separate hierarchies.

As described, embodiments presented herein provide techniques for resolving a label assigned to a common entity in one hierarchy to a label assigned to the entity in another hierarchy. Advantageously, the entity pool clearly defines relationships between entities such that a selected label may be efficiently matched with a corresponding label. As a result, users may make meaningful comparisons across multiple data sets, despite the data sets not sharing a common organizational or hierarchical structure. Further, because the entity pool may be further refined upon providing additional hierarchies, the techniques described herein are fully scalable.

In the preceding, reference is made to embodiments of the invention. However, the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet. In context of the present disclosure, the financial transparency application may be hosted on a cloud server. For example, the financial transparency application may be provided to subscribing users as a Software-as-a-Service. Further, the entity pool may be generated on cloud servers. More specifically, the financial transparency application may retrieve online sources to generate the entity pool, and the relation building component may define relationships between entities based on contextual information parsed from the online sources. Advantageously, as entity pool increases in size (e.g., as more entities are added to the entity pool), capacity to accommodate the increase may be easily provisioned to the cloud servers.

While the foregoing is directed to embodiments of the present invention, other and further embodiments of the invention may be devised without departing from the basic scope thereof, and the scope thereof is determined by the claims that follow.

1. A computer-implemented method for obtaining data corresponding to comparable elements in a first hierarchy and a second hierarchy, the method comprising:
receiving a selection of one or more elements in the first hierarchy;
identifying, by operation of one or more computer processors, a mapping from the one or more elements in the first hierarchy to a node in an entity pool; and
upon determining one or more elements in the second hierarchy map to the identified node in the entity pool:
retrieving data corresponding to the one or more elements in the first hierarchy and the one or more elements in the second hierarchy, and
returning the retrieved data.

2. The method of claim 1, wherein the entity pool provides a structure of nodes, wherein each node is associated with a collection of mentions, and wherein the mentions are collected from one or more public sources.

3. The method of claim 1, wherein the first hierarchy and the second hierarchy are associated with a first and second chart of accounts, and wherein elements in the first and second hierarchy correspond to items in the first and second charts of accounts, respectively.

4. The method of claim 2, further comprising, determining a plurality of relationships between nodes in the entity pool, wherein each relationship between a given first node and a second node is based on a measure of similarity between the mentions of the given first and second nodes.

5. The method of claim 1, further comprising, upon determining no element in the second hierarchy maps to the identified node:
identifying at least a first candidate node in the entity pool based on a similarity measure between the identified node and the first candidate node, wherein at least a first element in the second hierarchy maps to the first candidate node;
retrieving data corresponding to the one or more elements in the first hierarchy and at least the first element in the second hierarchy; and
returning the retrieved data.

6. (canceled)

7. The method of claim 5, further comprising, prompting for a confirmation to use the candidate node in a mapping from at least the first element in the second hierarchy to the candidate node.

8. The method of claim 1, further comprising, upon determining no element in the second hierarchy maps to the identified node, identifying one or more elements in the second hierarchy based on mentions associated with the identified node and an ontology relating the one or more elements in the first hierarchy to the one or more elements in the second hierarchy.

9. A non-transitory computer-readable storage medium storing instructions, which, when executed on a processor, performs an operation for obtaining data corresponding to comparable elements in a first hierarchy and a second hierarchy, the operation comprising:
receiving a selection of one or more elements of the first hierarchy;
identifying a mapping from the one or more elements in the first hierarchy to a node in an entity pool; and
upon determining one or more elements in the second hierarchy map to the identified node in the entity pool:
retrieving data corresponding to the one or more elements in the first hierarchy and the one or more elements in the second hierarchy, and
returning the retrieved data.

10. The computer-readable storage medium of claim 9, wherein the entity pool provides a structure of nodes, wherein each node is associated with a collection of mentions, and wherein the mentions are collected from one or more public sources.

11. The computer-readable storage medium of claim 9, wherein the first hierarchy and the second hierarchy are associated with a first and second chart of accounts, and wherein elements of the first and second hierarchy correspond to items in the first and second charts of accounts, respectively.

12. The computer-readable storage medium of claim 10, wherein the operation further comprises, determining a plurality of relationships between nodes in the entity pool, wherein each relationship between a given first node and a second node is based on a measure of similarity between the mentions of the given first and second nodes.

13. The computer-readable storage medium of claim 9, upon determining no element in the second hierarchy maps to the identified node:
identifying at least a first candidate node in the entity pool based on a similarity measure between the identified node and the first candidate node, wherein at least a first element in the second hierarchy maps to the first candidate node;
retrieving data corresponding to the one or more elements in the first hierarchy and at least the first element in the second hierarchy; and
returning the retrieved data.

14. (canceled)

15. The computer-readable storage medium of claim 13, wherein the operation further comprises, prompting for a confirmation to use the candidate node in a mapping from at least the first element in the second hierarchy to the candidate node.

16. A system, comprising:
a processor and
a memory hosting an application, which, when executed on the processor, performs an operation for obtaining data corresponding to comparable elements in a first hierarchy and a second hierarchy, the operation comprising:
receiving a selection of one or more elements of the first hierarchy;
identifying a mapping from the one or more elements in the first hierarchy to a node in an entity pool; and
upon determining one or more elements in the second hierarchy map to the identified node in the entity pool:
retrieving data corresponding to the one or more elements in the first hierarchy and the one or more elements in the second hierarchy, and
returning the retrieved data.

17. The system of claim 16, wherein the entity pool provides a structure of nodes, wherein each node is associated with a collection of mentions, and wherein the mentions are collected from one or more public sources.

18. The system of claim 16, wherein the first hierarchy and the second hierarchy are associated with a first and second chart of accounts, and wherein elements of the first and second hierarchy correspond to items in the first and second charts of accounts, respectively.

19. The system of claim 17, wherein the operation further comprises, determining a plurality of relationships between nodes in the entity pool, wherein each relationship between a given first node and a second node is based on a measure of similarity between the mentions of the given first and second nodes.

20. The system of claim 16, wherein the operation further comprises, upon determining no element in the second hierarchy maps to the identified node:
identifying at least a first candidate node in the entity pool based on a similarity measure between the identified node and the first candidate node, wherein at least a first element in the second hierarchy maps to the first candidate node;
retrieving data corresponding to the one or more elements in the first hierarchy and at least the first element in the second hierarchy; and
returning the retrieved data.

21. (canceled)

22. The system of claim 20, wherein the operation further comprises, prompting for a confirmation to use the candidate node in a mapping from at least the first element in the second hierarchy to the candidate node.

23. The method of claim 2, wherein at least a first one of the nodes is further associated with metadata characterizing the collections of mentions collected by the first node.

24. The computer-readable storage medium of claim 10, wherein at least a first one of the nodes is further associated with metadata characterizing the collections of mentions collected by the first node.

25. The system of claim 17, wherein at least a first one of the nodes is further associated with metadata characterizing the collections of mentions collected by the first node.

26. The computer-readable storage medium of claim 9, wherein upon determining no element in the second hierarchy maps to the identified node, the operation further comprises identifying one or more elements in the second hierarchy based on mentions associated with the identified node and an ontology relating the one or more elements in the first hierarchy to the one or more elements in the second hierarchy.

27. The system of claim 16, upon determining no element in the second hierarchy maps to the identified node, the operation further comprises identifying one or more elements in the second hierarchy based on mentions associated with the identified node and an ontology relating the one or more elements in the first hierarchy to the one or more elements in the second hierarchy.
